(19) United States
(12) Patent Application Publication
(10) Pub. No.: US 2007/0263894 A1
(43) Pub. Date: Nov. 15, 2007

(54) Bessel line source array

(75) Inventor: Enrique M. Stiles, Imperial Beach, CA (US)

Correspondence Address: RICHARD C. CALDERWOOD, 2775 NW 126TH AVE, PORTLAND, OR, 97229-8381, US

(73) Assignee: STEP Technologies Inc.

(21) Appl. No.: 11/880,215

(22) Filed: Jul. 21, 2007

Related U.S. Application Data
(63) Continuation-in-part of application No. 11/358,880, filed on Feb. 21, 2006.
(63) Continuation-in-part of application No. 11/358,810, filed on Feb. 21, 2006.
Application No. 11/358,880 is a continuation-in-part of application No. 11/220,935, filed on Sep. 6, 2005.
Application No. 11/220,935 is a continuation-in-part of application No. 10/896,215, filed on Jul. 20, 2004.

(51) Int. Cl. H04R 1/28

(52) U.S. Cl. 381/335

(57) ABSTRACT

An audio loudspeaker which includes a plurality of line source transducers arranged side by side and operated utilizing Bessel coefficient such that the loudspeaker as a whole operates as a line source within a line source operating frequency range. Optionally, the line source transducers may be operated in conventional line array fashion outside the frequency range in which the Bessel coefficients exhibit polar response benefit; for example, the line source transducers may all be driven with +1 coefficients below the Bessel coefficient frequency range to increase low frequency output. The loudspeaker may optionally include a tweeter that operates above the Bessel coefficient frequency range, and/or a woofer that operates below the Bessel coefficient frequency range.

### RELATED APPLICATION

This application is a continuation-in-part of U.S. patent application Ser. No. 11/358,880 entitled “Bessel Array with Full Amplitude Signal to Half Amplitude Position Transducers” and U.S. patent application Ser. No. 11/358,810 entitled “Bessel Array with Non-Empty Null Positions” both filed Feb. 21, 2006 by Enrique M. Stiles and Richard C. Calderwood. The '880 application was a continuation-in-part of application Ser. No. 11/220,935 entitled “Improved Bessel Array” filed Sep. 6, 2005 by Enrique M. Stiles, Patrick M. Turnmire, and Richard C. Calderwood; that application was in turn a continuation-in-part of application Ser. No. 10/896,215 entitled “Single-Sided Bessel Array” filed Jul. 20, 2004 by Enrique M. Stiles. All are commonly assigned to STEP Technologies Inc.

### BACKGROUND OF THE INVENTION

1. Technical Field of the Invention

This invention relates generally to arrays of audio loudspeakers, and more specifically to line source transducers arranged in a Bessel array.

2. Background Art

The vast majority of electroacoustic transducers function approximately as a point source, meaning that the sound pressure waves they produce propagate through the air as a spherical wave front, as though they had originated from a single point in space. A small minority of electroacoustic transducers function approximately as a line source, meaning that the sound pressure waves they produce propagate through the air as a cylindrical wave front, as though they had originated from an infinite line segment in space. An additional, small minority of electroacoustic transducers function approximately as a planar source, generating a planar wave front.

It is known to construct a loudspeaker as an array of multiple transducers, in order to increase the amount of air being moved by the loudspeaker, to increase the sound pressure level and/or bass extension that the loudspeaker is capable of producing. Most commonly, the multiple transducers are arranged in a simple line array, in which the multiple transducers are arranged in a typically vertical line and are driven with the same voice signal. For example, many home theater front left and front right channel loudspeakers are constructed each as a vertical column of three, four, or more conventional, reciprocating cone transducers. Unfortunately, each of these several transducers functions as an independent point source, but, due to the size of the transducers, the several points are separated by distances which are greater than a full wavelength of much of the upper portion of their operating frequency range. The physical spacing causes interference patterns, comb filtering, and the like, due in part to the different distances from any particular listening position to each of the multiple transducers, which results in phase incoherency.

The industry has known of, but almost not at all adopted, a technique whereby a linear array of physically separated point source transducers can be made to function almost as a single point source. U.S. Pat. No. 4,399,328 to Franssen teaches this technique, which is known as a “Bessel array.” The Bessel array operates by applying a predetermined mathematical pattern to the respective amplitudes and phase relationships of the various transducers.

Bessel arrays are typically constructed using five, seven, or nine transducer positions in a regular, linear pattern. In the five-transducer Bessel array, the first transducer receives a half-strength, in-phase signal (referred to as “+½”); the second transducer receives a full-strength, inverted-phase signal (referred to as “−1”); the third and fourth transducers each receives a full-strength, in-phase signal (“+1”); and the fifth transducer receives a half-strength, in-phase signal (“+½”). In the seven-transducer Bessel array, the coefficients are: −½, +1, −1, 0, +1, +1, and +½. The 0 coefficient represents a null or empty position; although a conventional Bessel array does not have a transducer at that position, the position is nevertheless present, for correct spacing purposes. In the nine-transducer Bessel array, the coefficients are: +½, −1, +1, 0, −1, 0, +1, +1, +½. Either end of the Bessel series may be designated the “top” end, and the other the “bottom” end. In the near field, a Bessel array exhibits somewhat different characteristics in positions off-axis toward the top end than toward the bottom end, but this effect is not significant, as the array may simply be inverted to select the desired set of characteristics, and is negligible in the far field for conventional Bessel arrays.

Previously, the only known purpose of the Bessel array was to make a multi-transducer array resemble, as much as possible, a point source. Virtually all transducer experts have been of the opinion that a point source is the “ideal” toward which all designs should strive.

However, this inventor believes that in many, if not most, applications, a line source is the better ideal.

Unfortunately, most line source transducers, such as ribbon transducers, planar magnetic transducers, and Heil air motion transformers, are not capable of moving the very significant amounts of air necessary for producing very high sound pressure levels, especially in low frequencies. The Heil air motion transformer was invented by Oskar Heil, and is disclosed in U.S. Pat. Nos. 3,636,278 and 3,832,499 and 4,107,479.

What is needed, is a loudspeaker which functions as a line source, with improved sound pressure capabilities and/or low-end response, but without significant degradation in its off-axis characteristics.

### BRIEF DESCRIPTION OF THE DRAWINGS

FIG. 1 shows a loudspeaker including a line source Bessel array of planar magnetic transducers, in perspective view.

FIG. 2 shows a cross-section view of the line source Bessel array of FIG. 1.

FIG. 3 shows a loudspeaker including a five-driver line source Bessel array of ribbon transducers, in perspective view.

FIG. 4 shows a cross-section view of the five-driver line source Bessel array of FIG. 3.

FIG. 5 shows the loudspeaker of FIG. 3 in a nearly side view, demonstrating its line source Bessel array reversibly mounted to a subwoofer enclosure to facilitate two different horizontal placings of the line source Bessel array with respect to a backmost portion of the subwoofer cabinet.

FIG. 6 shows a block diagram view of an audio system utilizing a line source Bessel array.

FIG. 7 shows a block diagram view of an audio system having two line source Bessel array loudspeakers each equipped with switching means for the user to specify one as a left channel loudspeaker and the other as a right channel loudspeaker.

FIG. 8 shows a loudspeaker according to another embodiment of this invention, using ribbon or planar magnetic transducer technology.

FIG. 9 shows the loudspeaker of FIG. 8 in a nearly top view.

FIG. 10 shows a loudspeaker according to another embodiment of this invention, using Heil air motion transformer technology.

FIG. 11 shows the loudspeaker of FIG. 10 in a nearly top view, sectioned as indicted in FIG. 10.

FIG. 12 shows the loudspeaker of FIG. 10 in an exploded view.

FIG. 13 shows a loudspeaker according to another embodiment of this invention, using Heil air motion transformer technology.

FIG. 14 shows the loudspeaker of FIG. 13 in top view.

FIG. 15 shows one embodiment of a simplified Heil air motion transformer diaphragm with conductive traces, forming five distinct transducer sections for Bessel array operation.

FIG. 16 shows one embodiment of a simplified planar magnetic diaphragm, with magnets, such as may be used in FIG. 8.

FIG. 17 shows one embodiment of a simplified 7-ribbon line source Bessel array.

FIG. 18 shows another embodiment of a line source Bessel array loudspeaker.

FIG. 19 shows another embodiment of a line source Bessel array loudspeaker using line arrays of conventional moving cone transducers.

FIG. 20 shows another embodiment, in which the line arrays are vertically staggered to enable improved horizontal packing.

FIG. 21 shows another embodiment, in which the line arrays are not parallel and the Bessel array as a whole has a trapezoidal shape.

FIG. 22 shows another embodiment, in which the line arrays are curved and the Bessel array as a whole has an hourglass shape.

FIG. 23 shows another embodiment, in which the line arrays are curved and the Bessel array as a whole has a barrel shape

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

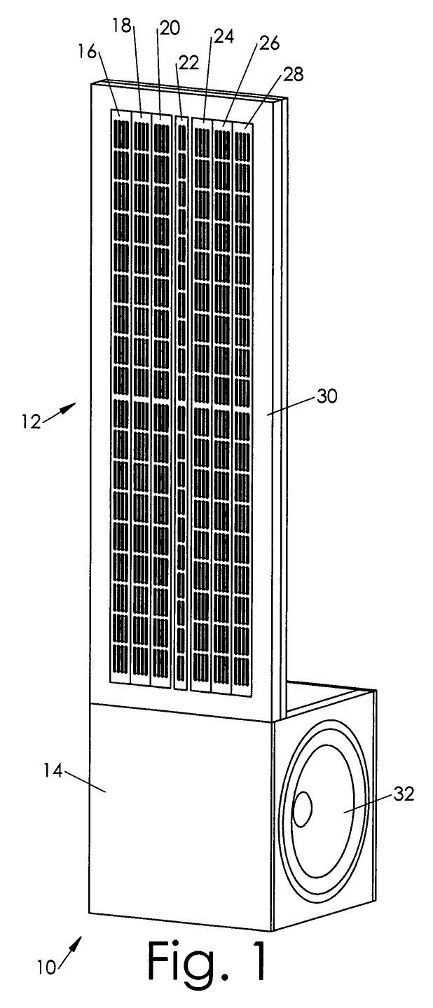

FIG. 1 illustrates a loudspeaker 10 according to one embodiment of this invention. The loudspeaker includes a line source Bessel array loudspeaker 12 and, optionally, a subwoofer 14 which may serve as a base supporting the line source Bessel array loudspeaker.

The line source Bessel array loudspeaker includes a plurality of line source transducers arranged in Bessel array fashion, that is, on regular spacing and operated with appropriate amplitude and phase coefficients. In the embodiment shown, there are seven line source transducers 16 through 28, but in other embodiments there may be five, nine, or other numbers. The line source transducer 22 which occupies the 0 coefficient position may be omitted. Or, advantageously, it may be a line source transducer which, either simply by its nature or by virtue of a cross-over (not shown), ideally only produces sound above the frequency range in which the other Bessel transducers are operating in Bessel fashion. For example, the other line source transducers 16 through 20 and 24 through 28 may be midrange planar magnetic transducers, and the 0 position line source transducer 22 may be a tweeter. Optionally, the 0 position transducer could even be a single point source transducer, or an array of point source transducers.

The line source transducers may be coupled to a baffle 30. The loudspeaker is shown as having its line source transducers oriented in a vertical direction, such that the Bessel positions are horizontal from each other. The transducers may, of course, be oriented in other directions, according to the needs of the application at hand.

In one embodiment, the subwoofer may include a pair of opposed, side-firing, conventional cone drivers 32 (only one visible in the drawing). In other embodiments, the subwoofer may have any other configuration whatsoever.

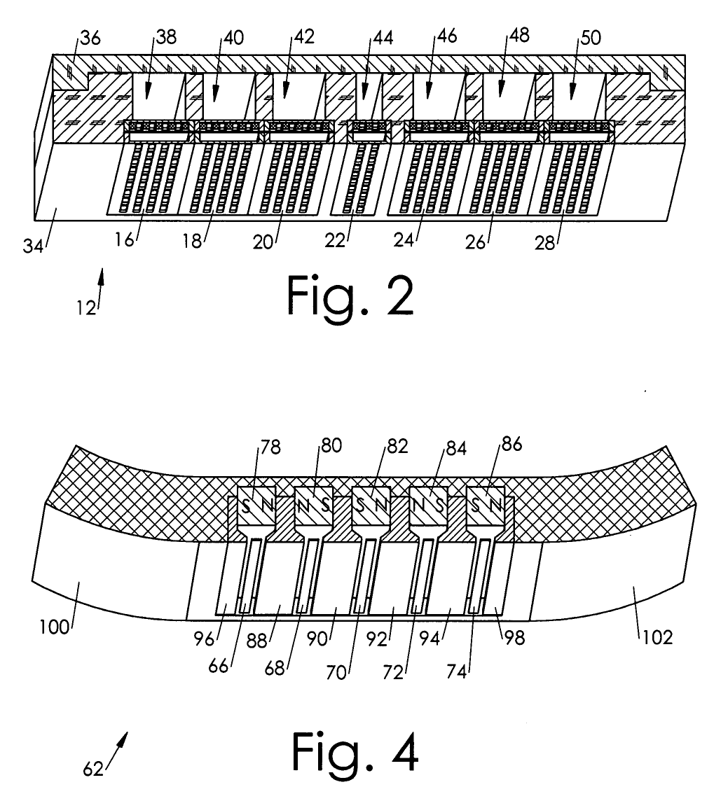

FIG. 2 illustrates the line source Bessel array loudspeaker 12 in cross-section. The baffle includes a front panel 34 and a rear panel 36, optionally configured to provide enclosed air volumes 38 through 50 behind corresponding transducers 16 through 28 at the respective Bessel positions.

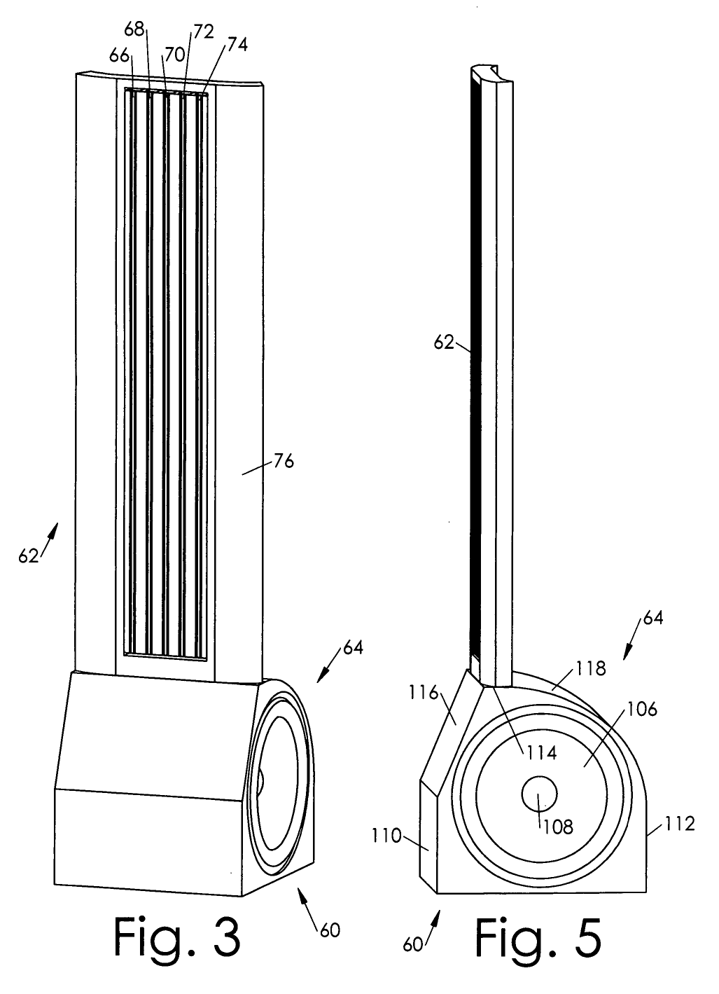

FIG. 3 illustrates a loudspeaker 60 according to another embodiment of this invention. The loudspeaker includes a five-driver line source Bessel array loudspeaker 62 optionally mounted to a subwoofer 64. The line source Bessel array includes a plurality of line source ribbon transducers 66 through 74 optionally coupled to a frame 76. The line source Bessel array is shown as a five-transducer array, but any Bessel number can be used.

FIG. 4 illustrates the line source Bessel array loudspeaker 62 in cross-section, showing the ribbons 66 through 74 of the line source transducers. In the embodiment shown, the transducers share a common magnetic circuit structure, having opposing polarity magnets 78 through 86 sandwiching steel (or equivalent) pole pieces 88 through 94, with end pole pieces 96 and 98.

Optionally, the frame 76 includes side portions 100, 102 which extend outward from the line source transducers to reduce edge diffraction. The side portions may be curved (as shown) or they may be planar.

By appropriately shaping the geometry of the end pole pieces 96 and 98, the strength of the flux in the magnetic air gaps for the outer ribbons 66 and 74 can be made to inherently approach the ½ magnitude for their Bessel positions. In some geometries, this may be accomplished by providing leakage paths for the magnetic flux at the rear of the motor structure.

FIG. 5 illustrates the loudspeaker 60 in a slightly canted side view, particularly showing one advantageous configuration of the subwoofer (or other base) 64. The subwoofer includes one or more transducers 106 which may optionally be mounted at a center 108 of the subwoofer cabinet as measured from the front 110 to the rear 112 of the subwoofer cabinet. The cabinet includes a surface 114 to which the line source Bessel array is coupled. In some embodiments, this mounting location may be offset (front-to-rear) from the center of the cabinet, and the line source Bessel array may be removably and reversibly mounted to the subwoofer.

With the line source Bessel array mounted with its front facing what is nominally shown as the front 110 of the subwoofer cabinet, there is a first distance from the front of the line source Bessel array to the nominal rear 112 of the subwoofer cabinet. With the line source Bessel array mounted with its front facing what is nominally shown as the rear 112 of the subwoofer cabinet, there is a second, different distance from the front of the line source Bessel array to the nominal front 110 of the subwoofer cabinet (which is then the effective rear of the cabinet). This reversibility enables the user to select a depth positioning of the line source Bessel array to e.g. bring it into a desired depth position with respect to a television screen (not shown), especially in systems in which the television's built-in loudspeakers are used as the center channel of 5.1 or 7.1 home theater system.

The subwoofer cabinet surfaces 116, 118 which are adjacent the lower edge of the line source Bessel array (in its two reversible configurations) may be flat or curved, as shown.

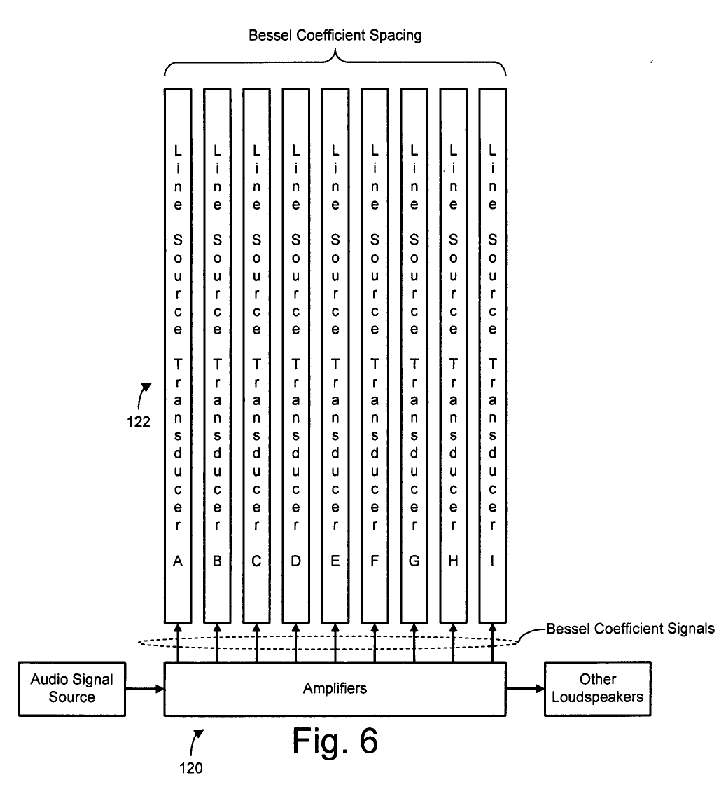

FIG. 6 illustrates an audio system 120 according to the principles of this invention. The audio system includes an audio signal source providing an audio signal to one or more amplifiers. The amplifier(s) drive(s) a line source Bessel array 122 with the correct number, amplitude, and phase Bessel coefficient signals. The audio system may include two or more such line source Bessel arrays (for the various left, right, center, etc. channels), although, for convenience, only one is shown. The audio system may also include other loudspeakers, such as a subwoofer or surround satellites, which are not necessarily line source Bessel arrays.

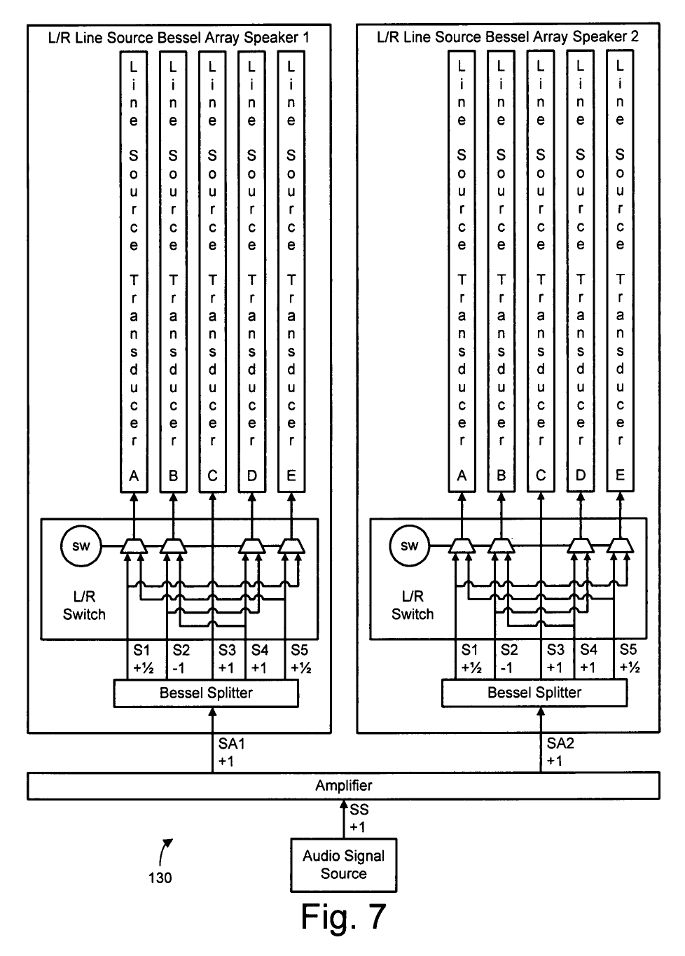

FIG. 7 illustrates an audio system 130 according to yet another embodiment of this invention. An audio source provides a signal SS to an amplifier. The amplifier (or amplifiers) provides an amplified first audio channel signal SA1 and an amplified second audio channel signal SA2, which may be, respectively, left and right audio channel signals. Each audio channel signal has a +1 Bessel value, meaning that it is considered to be full amplitude and in phase.

The SA1 and SA2 signals are provided, respectively, to first and second line source Bessel array loudspeakers (“L/R Line Source Bessel Array Speaker I” and “L/R Line Source Bessel Array Speaker 2”). Each of the loudspeakers includes a line source Bessel array, illustrated as a five-transducer array of transducers A through E. Each of the loudspeakers includes a Bessel splitter which receives that channel's signal from the amplifier and outputs the appropriate quantity of Bessel coefficient signals each of the appropriate amplitude and phase, illustrated as signals S1 through S5 having coefficients of +½, −1, +1, +1, and +½, respectively.

Optionally, the Bessel splitter (or another component) can be configured to operate the transducers in Improved Bessel or Super Bessel manner, as taught in the co-pending applications.

The Bessel signals S1 through S5 are passed through a left/right switch (“L/R Switch”) which includes a user-selectable switch (“sw”) which controls logic or circuitry which routes the Bessel signals to the appropriate transducers.

In the five-transducer example shown, when the switch is in the Left position, the S1 signal is routed to Transducer A, the S2 signal is routed to Transducer B, the S3 signal is routed to Transducer C, the S4 signal is routed to Transducer D, and the S5 signal is routed to Transducer E. When the switch is in the Right position, the S1 signal is routed to Transducer E, the S2 signal is routed to Transducer D, the S3 signal is routed to Transducer C, the S4 signal is routed to Transducer B, and the S5 signal is routed to Transducer A.

This gives the user the ability to select which side of the line source Bessel array (the Transducer A side or the Transducer E side) is the “top” of the Bessel array. As some versions of Bessel arrays (such as Super or Improved Bessel arrays) exhibit somewhat different off-axis characteristics toward the “top” (the position 1 transducer) than toward the “bottom”, the user may be able to optimize his listening environment by appropriately setting the L/R switches of the two line source Bessel array loudspeakers. In most cases, it may be found that the “top” should be closer to the middle of the listening environment (i.e. toward the center channel), but this may not always be the case, depending upon many factors in the particular amplifier system and/or listening environment.

In some embodiments, a single switch may control the L/R Switches of both loudspeakers in an L/R pair.

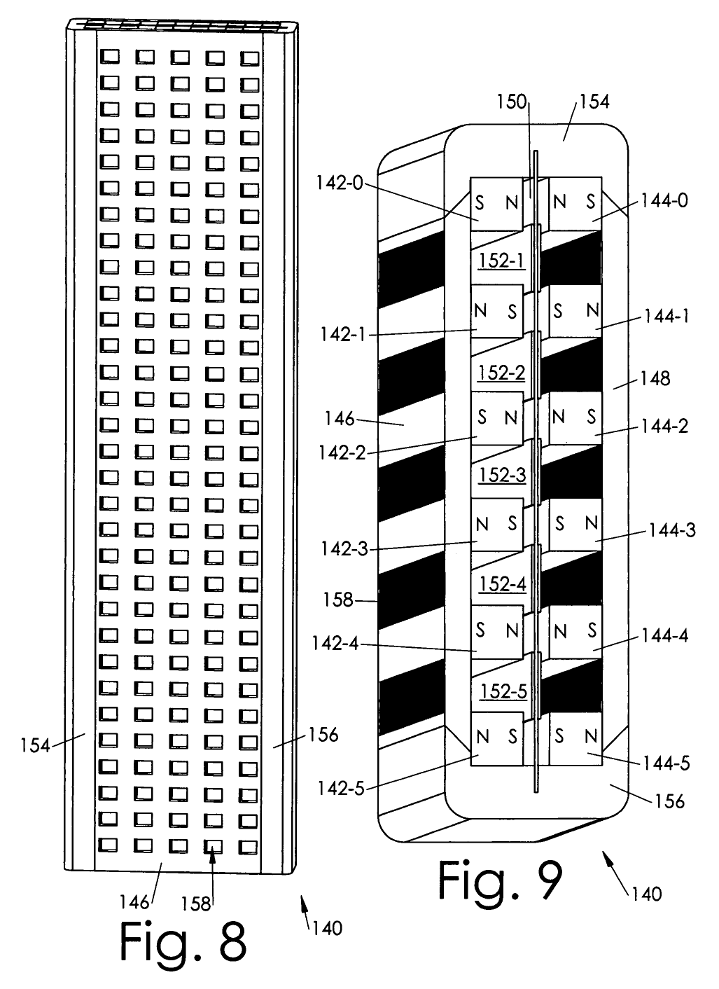

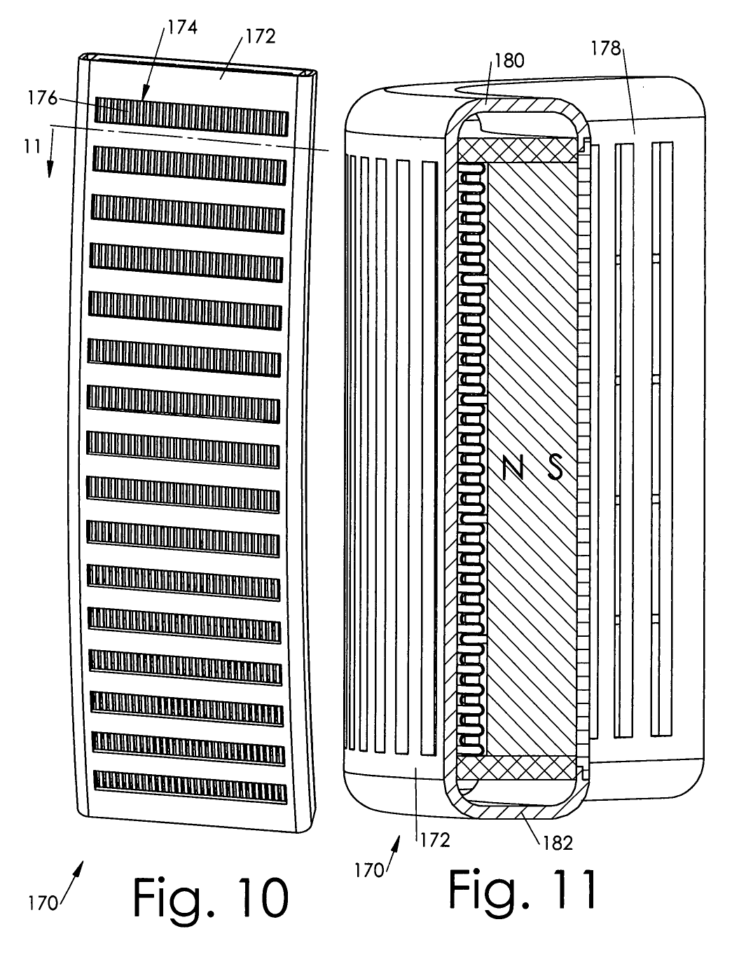

FIGS. 8 and 9 illustrate a Bessel array loudspeaker 140 according to another embodiment of this invention, in a generally front view and a generally top view, respectively. The loudspeaker behaves as a line source in mid to high frequencies and gradually transitions to a point source in lower frequencies where the height of the array is shorter than the wavelength. The terms “front”, “rear”, “left”, and “right” should be understood to refer to the orientation shown in FIG. 8, not FIG. 9, lest the reader be confused. In FIG. 8, the front is facing out of the page, while in FIG. 9, the front is facing to the left of the page.

The loudspeaker includes a plurality of front magnets 142-0 to 142-5 and/or a plurality of rear magnets 144-0 to 144-5. The front magnets are magnetically coupled to a magnetically conductive front grille 146 and the rear magnets are magnetically coupled to a magnetically conductive rear grille 148. The front and rear magnets are polarized front to back with respect to the loudspeaker, and are arranged in pairs. A sheet diaphragm 150 is suspended between the front and rear magnets, and has electrically conductive traces 152-1 through 152-5 disposed in the spaces between adjacent magnet pairs; as shown, the traces may slightly overlap into the spaces between the magnets.

Within each pair, the two magnets are oppositely polarized, such that the magnetic flux is directed laterally left or right generally in the plane of the diaphragm. Adjacent pairs of magnets are oppositely polarized, creating a strong magnetic field directed laterally left or right through a given electrical trace. The front grille serves as a magnetic flux return path for adjacent front magnets, and the rear grille serves as a magnetic flux return path for adjacent rear magnets. There may be traces on one side of the diaphragm, or on both sides of the diaphragm, according to the needs of the application at hand.

Side caps 154 and 156 are not magnetically conductive and they mechanically hold the structure together. The left and right margins of the diaphragm may advantageously be fastened to the side caps. The front grill includes columns of holes 158 which, although they take away from the magnetic circuit, permit sound to pass from the diaphragm to the listening environment.

The N traces (in this example N=5) function as the N transducers of the line source Bessel array. Because the magnetic flux flows in opposite directions (left to right, or right to left), the direction (up or down) of the electrical signals must be correctly thought through, to create the correct and desired Bessel coefficients at the N transducers.

Because the N transducers are formed using a single, monolithic sheet diaphragm, this loudspeaker is particularly benefited from also employing this inventor's “Improved Bessel” and/or “Super Bessel” inventions described in the above-mentioned co-pending applications. For example, in frequencies below the range in which it is advantageous to operate the N transducers in Bessel fashion, the various transducers can be “cheated” toward the +1 coefficient, enabling the whole diaphragm to function as a single woofer or subwoofer. −½ coefficient transducers can be instead be operated in that low frequency range as 0, +½, or, ideally, +1 coefficient transducers; and −1 coefficient transducers can ideally be operated as +1 coefficient transducers (or, less desirably, −½, 0, or +½ coefficient transducers); and +½ coefficient transducers can be operated as +1 transducers. In the best case, the N transducers produce 2 transducers' worth of sound output in the Bessel range, and N transducers' worth of sound output in the lower frequencies below the Bessel range.

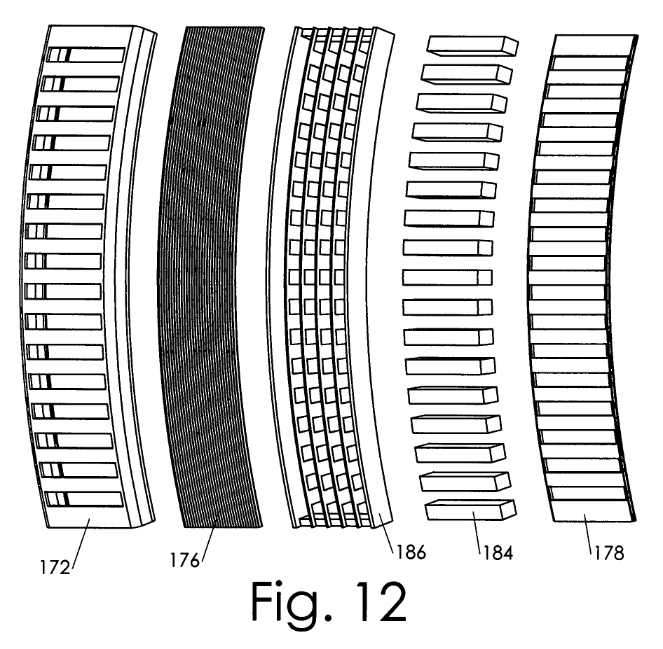

FIGS. 10-12 illustrate a line source Bessel array loudspeaker 170 according to another embodiment of this invention, using Heil air motion transformer technology, in generally front view, generally top view, and exploded view, respectively. The same “left”, “right”, etc. cautionary note applies here as with FIGS. 8 and 9.

The loudspeaker includes a front grille 172 equipped with holes 174 permitting sound from the diaphragm 176 to reach the listening environment. A rear grille 178 is advantageously magnetically coupled to the front grille; in one embodiment, the front grille includes side portions 180, 182 which wrap around to mate with the rear grille.

A plurality of magnets 184 are coupled to the rear grille. The magnets are polarized in the same direction, front to back. A pleated Heil air motion transformer diaphragm 176 is disposed between the magnets and the front grille. Optionally, a frame 186 holds the magnets and the diaphragm in position. In some embodiments, adjacent transducers having the same Bessel coefficients (e.g. +1 and +1 in the five-transducer Bessel at positions 3 and 4) may be constructed as a single transducer of double width as long as there is no change in the effective piston radiating area, conductor length, or compliance versus the other transducers.

The loudspeaker need not necessarily have a planar overall shape. Rather, in some applications, it may be advantageous to give the loudspeaker a curved “potbelly” shape (e.g. convex with the middle protruding into the listening space farther than the top and bottom) to improve vertical coverage. In other applications, it may be desirable to give the loudspeaker a slightly curved “cylindrical” shape (e.g. convex with the middle protruding into the listening space farther than the sides). In still other applications, it may be advantageous to combine the two curvatures such that the transducer is a “barrel source”.

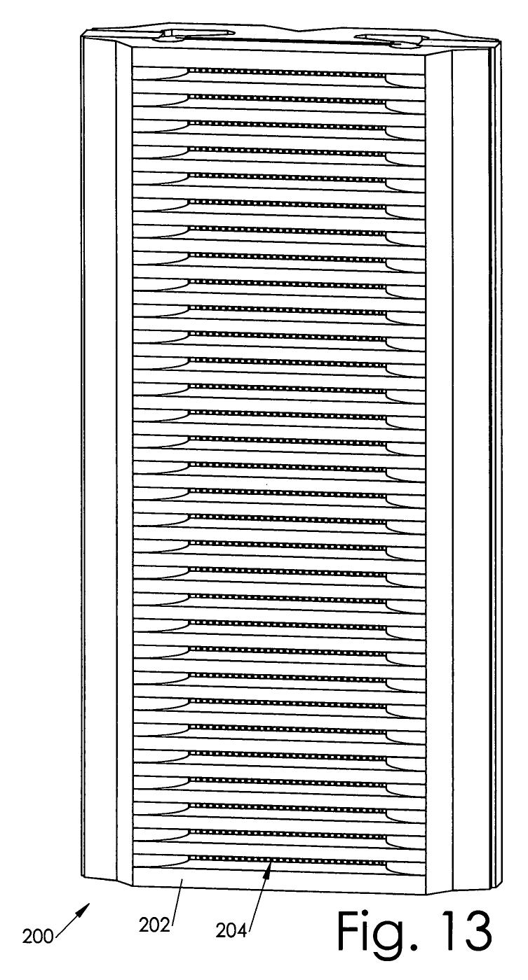

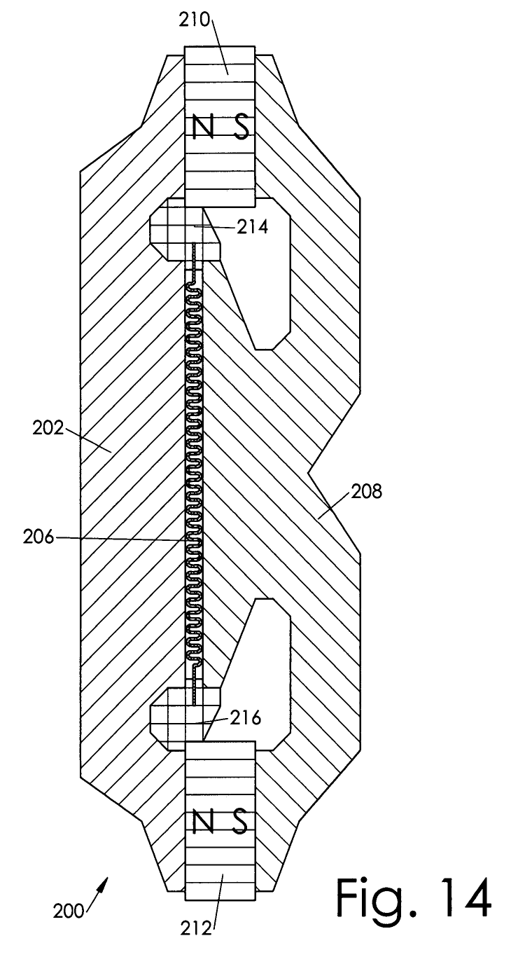

FIGS. 13 and 14 illustrate a loudspeaker 200 according to yet another embodiment of this invention, using Heil air motion transformer technology, in nearly front view and in top view, respectively. The loudspeaker includes a front yoke 202 which is provided with a plurality of slots or holes 204 enabling sound to pass from the pleated diaphragm 206 to the listening environment. In one embodiment, the front yoke is constructed as a monolithic whole, with the slots being cast or machined into it. In another embodiment, the front yoke is constructed as a laminated structure of alternating full and partial (spacer) layers.

A rear yoke 208 is disposed behind the diaphragm. Like the front yoke, the bottom yoke may be constructed as a monolithic whole or as a laminated structure of alternating full and partial (spacer) layers, to depressurize the back surface of the diaphragm. The loudspeaker may be free-standing and operate as a dipole, or it may be mounted to a cabinet (not shown) such that only the front surface radiates sound into the listening environment.

A pair of magnets 210, 212 are magnetically coupled to the front and rear yokes, forming a magnetic circuit which includes a magnetic air gap in which the diaphragm is disposed. The left and right sides of the diaphragm may be mounted to one of the yokes, or to the magnets, or they may mounted to a pair of magnetically non-conductive spacers 214, 216 as shown.

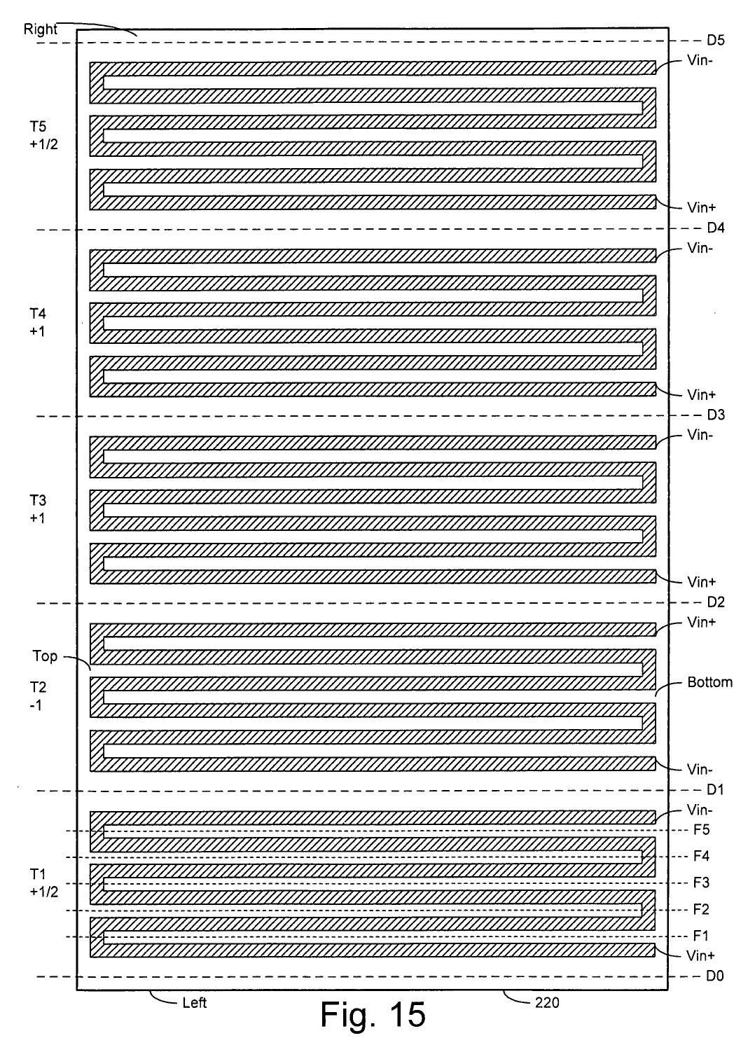

FIG. 15 illustrates an exemplary, simplified diaphragm 220 such as may be employed in any of the Heil air motion transformer embodiments. For convenience of illustration, the diaphragm has been rotated 90° to the left on the page, versus e.g. FIG. 10 or 13. For clarity, the Top, Bottom, Left, and Right of the diaphragm have been labeled.

The diaphragm includes distinct regions forming N Bessel transducers. In the example shown, there are five transducers T1 through T5, having Bessel coefficients of +½, −1, +1, +1, and +½, respectively.

Each transducer includes a serpentine trace (shown in hatching) which has long runs up and down the diaphragm, with short runs at the top and bottom connecting the long runs. The diaphragm is folded or pleated between the long runs, e.g. at areas F1 through F5, such that each long run will be facing toward one of its two neighbors and away from the other. The particular transducer's respective Bessel coefficient voice signal is applied to the ends of that transducer's “voice coil” trace, with the Vin+ positive input signal being applied to one end, and the Vin-negative input signal (or ground signal) being applied to the other end. Note that the ends of the inverse phase transducer's (T2) conductor can simply be coupled to the input terminals “backward” with respect to the positive phase transducers' conductors. The half-amplitude signals can be generated in any suitable manner.

In Improved and Super Bessel embodiments, the N transducers are operated in Bessel fashion within the Bessel frequency range, and in Improved or Super Bessel fashion below that range, as is taught in the co-pending applications.

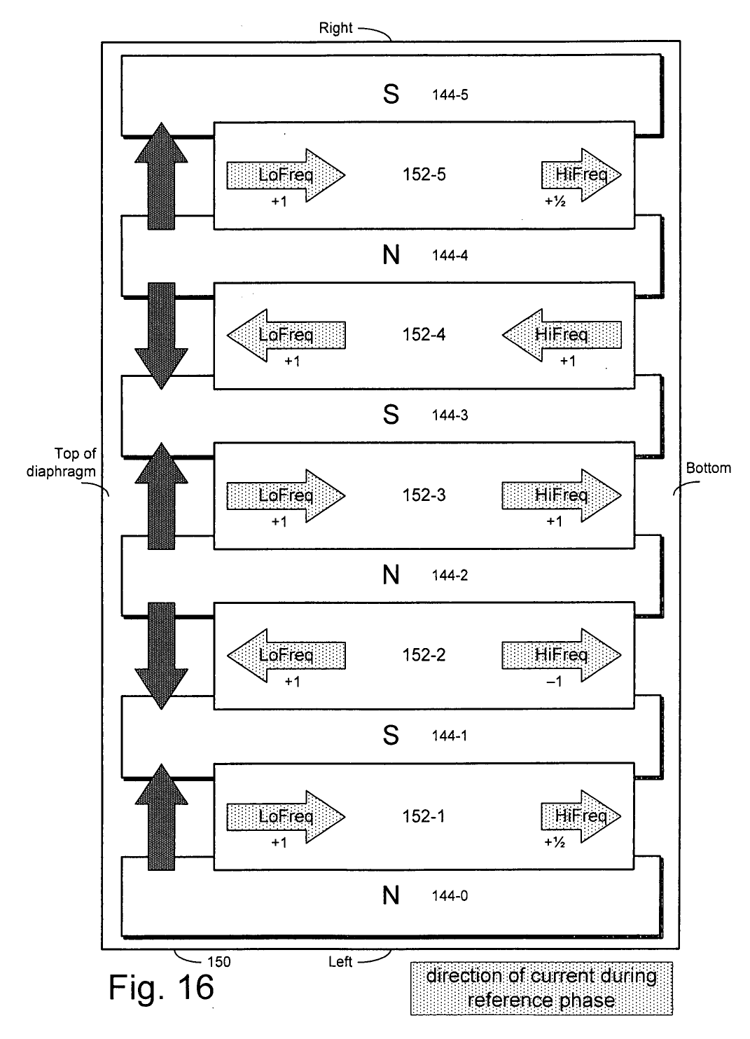

FIG. 16 illustrates the function of the planar magnetic loudspeaker diaphragm 150 of FIG. 8, in a front view rotated 90° left versus the view of FIG. 8. Reference should also be made to FIG. 9. The top, bottom, left, and right of the diaphragm are labeled as such in FIG. 16; these are functional notations which are 90° different from the portrait view orientation of the page.

The diaphragm is shown as though it were transparent, permitting the reader to view the rear magnets 144-0 through 144-5 which are behind the diaphragm. The magnets are polarized front-to-back with their front polarities visible in the drawing. The front magnets (not shown) are located directly in front of the rear magnets and are of opposite polarity. The magnetic flux is “squeezed out” from between them, and travels in the directions shown by the darker shaded arrows, generally in the plane of the diaphragm.

The diaphragm is provided with a plurality of electrically conductive traces or wires 152-1 through 152-5, each of which forms a distinct one of the line source Bessel array transducers. The traces are located in the spaces between adjacent rear magnets, and optionally may slightly overlap the magnets as shown.

The lighter shaded arrows on the traces indicate the direction or “positive orientation” of the electrical signal applied to the respective traces. This direction is dictated by the combination of the desired Bessel coefficient and the direction of the magnetic flux at that transducer location. For example, let us use transducer 152-1 as our reference, with the other transducers being compared to it for purposes of “in phase” and “opposite phase” operation. Transducer 152-1 has a +½ Bessel coefficient in the high frequency range (and a +1 coefficient in low frequencies below the Bessel frequency range) and is in a left-to-right flux region. And let us arbitrarily select the downward current direction as the positive orientation for a transducer having a left-to-right flux region. During operation of transducer 152-1, when the electrical current is in the functionally downward direction (toward the right of the portrait orientation of the page) shown by the light grey arrows, transducer 152-1 will, per Fleming's Left Hand Rule, be thrust outward from the page toward the reader. This is the reference against which other transducers in the loudspeaker will be compared; when we say that another transducer's current flows in a particular direction, the reader should understand that this is during times when the reference transducer's current is flowing in the downward direction—the “reference phase”.

In the high frequency Bessel operation range, this current is of half amplitude, to achieve the +½ output, and in lower frequencies below the Bessel operation range, this current can be either half amplitude (for Improved Bessel operation) or full amplitude (for Super Bessel operation).

Transducers 152-3 and 152-5 are also in magnetic fields which go left-to-right (in the functional orientation which is 90° different than the portrait orientation of the page). When electric current passes from the labeled top toward the labeled bottom of their conductors, they will be thrust outward from the page toward the reader. But transducers 152-2 and 152-4 are in magnetic fields which go right-to-left; in order for them to be thrust outward from the page toward the reader, they must be fed an electric current which flows from the labeled bottom toward the labeled top of the page.

Within the high frequency Bessel operation range, transducer 152-2 is supposed to have an opposite phase, full-amplitude output (−1). So, within the Bessel operation frequency range, transducer 152-2 is driven by an electric current which flows (during the reference phase) from the labeled top to the labeled bottom of the diaphragm. Although this is in the same direction as the current applied to reference transducer 152-1, this transducer 152-2 is in a reversed magnetic flux region compared to the reference, and thus its output will be opposite phase. In frequencies below the Bessel operation range, the transducer 152-2 may be driven (during the reference phase) with a signal which flows in the opposite direction, from the bottom to the top of the diaphragm in order to achieve increased low frequency output. Alternatively, a 0 signal could be applied to transducer 152-2 below the Bessel operation range; it would then not be contributing to bass output of the loudspeaker, but would at least not be subtracting from it.

Within the high frequency Bessel operation range, transducer 152-3 is supposed to have an in-phase, full amplitude output (+1). Because transducer 152-3 is in a left-to-right flux field, as is the reference transducer, transducer 152-3 is driven (during the reference phase) with a signal which flows from the labeled top to the labeled bottom of the diaphragm. Below the Bessel operation range, this same signal can be applied, so the transducer has a +1 output there, as well.

Within the high frequency Bessel operation range, the transducer 152-4 is supposed to have a +1 in-phase, full-amplitude output. Because it is in a right-to-left flux field, during the reference phase its current must flow from the labeled bottom to the labeled top of the diaphragm. Below the Bessel operating range, it can be driven with the same signal.

Within the high frequency Bessel operation range, the last transducer 152-5 is supposed to have a +½ in-phase, half-amplitude output. Because it is in a left-to-right flux field, during the reference phase it is driven with a current which flows top to bottom, just like the reference transducer. Below the Bessel operation range, it can be driven with a +½ signal (for Improved Bessel operation) or, as shown, with a +1 signal (for Super Bessel operation).

The distance between adjacent edges of adjacent traces should be selected, in part, depending upon the flexibility of the diaphragm material. The diaphragm material may be uniformly flexible and/or elastic, or it may exhibit some anisotropy. Specifically, it may be desirable that the diaphragm be more flexible and/or elastic in the left-right dimension than in the up-down dimension.

In some embodiments, the traces are relatively narrow left to right, and the diaphragm substrate itself provides the majority of the radiating surface to create sound pressure. In other embodiments, the traces are relative wide left to right and they themselves provide the majority of the radiating surface to create sound pressure. In the former, it may be desirable to have a relatively stiff diaphragm substrate, and in the latter it may be desirable to have a relatively limp diaphragm substrate.

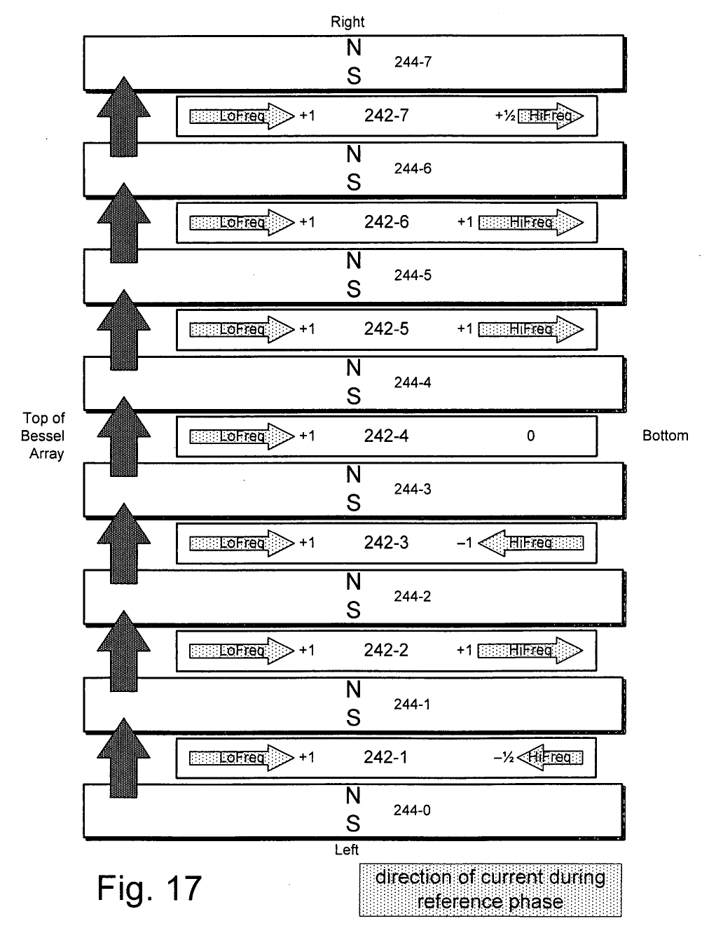

FIG. 17 illustrates a line source Bessel array using seven ribbon transducers 242-1 through 242-7. The top, bottom, left, and right of the Bessel array are labeled, and are 90° different than the portrait view of the page.

The conductive ribbons are disposed between magnets 244-0 through 244-7. All of the magnets are polarized left-to-right as shown. In the embodiment shown, the magnetic flux travels in the same left to right direction over all of the ribbons. In another embodiment, the right half magnets 244-4 through 244-7 could be polarized in the opposite direction, with the middle position 244-4 occupied with a portion of a yoke for providing a magnetic flux return path for each half's magnets rather than there being a ribbon in the 0 position.

Whereas in FIG. 16 the diaphragm and its traces were located slightly in front of the magnets, in FIG. 17 the ribbons are disposed directly between the magnets. In some embodiments, the left and right sides of the magnets may be equipped with steel focusing strips (not shown) which gather flux from a deep magnet and focus it into a shallower region of increased magnetic flux density, to improve the BL of the transducer; the magnets are “deep” in the direction in and out of the page, and the focusing strips create high magnetic flux regions which are shallower in and out of the page (although the flux will still flow laterally, as shown).

Because the ribbon 242-1 has an opposite-phase output in the Bessel operation range, the ribbon 242-2 will be used as the reference transducer.

In the high frequency Bessel operating range, reference ribbon 242-2 is to have a +1 output. Thus, in the reference phase, the reference ribbon is driven with a current which flows from the labeled top to the labeled bottom of the page, causing it to be thrust outward toward the reader during the reference phase. In frequencies below the Bessel operation range, the reference ribbon is also driven with a current which flows from the labeled top to the labeled bottom during the reference phase.

In the high frequency Bessel operating range, ribbon 242-1 is to have an opposite-phase, half-amplitude (−½) output, and thus is driven during the reference phase with a current which flows from the labeled bottom to the labeled top of the Bessel array. In lower frequencies below the Bessel operation range, the reference transducer can be left undriven (to produce a 0 output), or driven with a half-amplitude signal which flows from the labeled top to the labeled bottom (to produce a +½ output), or, as shown, driven with a full-amplitude signal which flows from the labeled top to the labeled bottom (to produce a +1 output).

In the high frequency Bessel operation range, the ribbon 242-3 is to have a −1 opposite-phase, full-amplitude output. During the reference phase, it is driven with a current which flows from the labeled bottom to the labeled top of the Bessel array. In lower frequencies below the Bessel operation range, it may be driven during the reference phase with a current which flows from the labeled top to the labeled bottom of the page. In one mode, this current has a 0 value, and in another mode it has a +1 value.

In the high frequency Bessel operation range, the middle position 242-4 is to produce a 0 output. In some embodiments, the ribbon at that position can simply be omitted. In other embodiments, that position can be occupied with a supertweeter which operates only at frequencies above the Bessel operating range so as to not interfere with the Bessel functionality. And in the embodiment shown, that position can be occupied with a ribbon which is left undriven in the Bessel operating range, but which is driven with +1 current flowing from the labeled top to the labeled bottom to contribute to the lower frequency output of the Bessel array.

Ribbons 242-5 and 242-6 are functionally the same as ribbon 242-2.

In the high frequency Bessel operation range, ribbon 242-7 is to produce an in-phase, half-amplitude +½ output. During the reference phase, it is driven with a half-amplitude current flowing from the labeled top to the labeled bottom of the Bessel array. In lower frequencies below the Bessel operation range, it can be driven with this same signal, or, as shown, it can be driven with a full-strength current which flows from the labeled top to the labeled bottom during the reference phase.

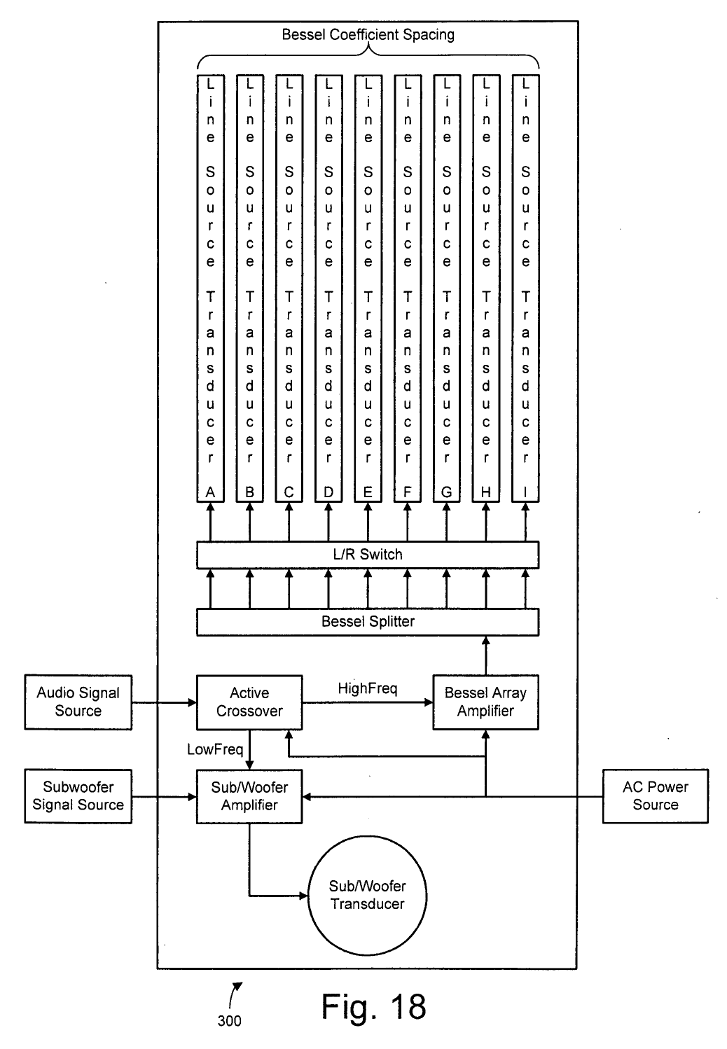

FIG. 18 illustrates an embodiment of a powered (self-amplified) loudspeaker having a line source Bessel array, particularly suitable as a left or right channel loudspeaker for use in a home theater or music system. The loudspeaker includes any suitable number of vertically oriented line source transducers arranged in parallel on equal horizontal spacing, and one or more woofer or subwoofer transducers. Advantageously, the woofer may be positioned vertically below the line source Bessel array.

The loudspeaker includes an input terminal for receiving a channel of voice signal from an audio signal source such as the line-level outputs of a home audio receiver or pre-amplifier. The loudspeaker includes an active crossover filter which splits the channel voice signal into a high frequency signal and a low frequency signal. The high frequency signal is provided to a Bessel array amplifier, whose output is fed to the Bessel splitter which generates the Bessel coefficient signals which drive the line source Bessel array's respective transducers. Optionally, the loudspeaker includes a left/right switch which determines the order (left to right, or right to left) in which the Bessel coefficient signals are applied to line source transducers. The low frequency signal is provided to a sub/woofer amplifier whose output drives the sub/woofer transducer.

The loudspeaker further includes a woofer amplifier. Optionally, the woofer amplifier may receive a subwoofer channel signal from a subwoofer signal source (such as the subwoofer output of a 5.1 audio receiver), in lieu of the low frequency signal coming from the active crossover.

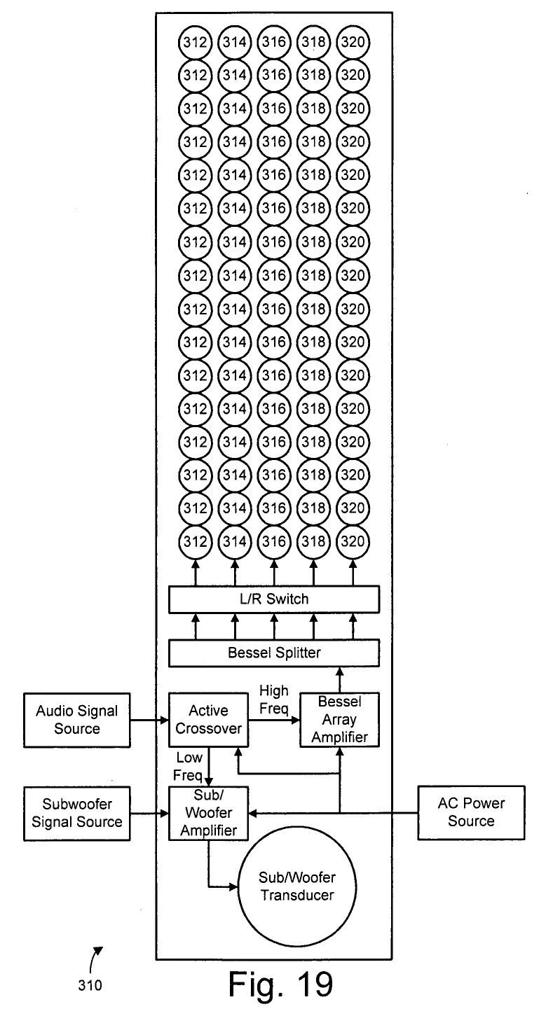

FIG. 19 illustrates another embodiment of a loudspeaker 310 utilizing the principles of this invention with conventional reciprocating piston electromagnetic transducers rather than ribbon transducers or planar magnetic transducers or the like.

The loudspeaker includes a plurality of line arrays 312 to 320. Each line array includes a plurality of individual drivers (transducers) which may be of the conventional moving cone type. Each line array is wired in conventional line array fashion, rather than in e.g. Bessel array fashion, such that it functions as a line source rather than a point source. The line sources are then wired, as a group, to operate in Bessel array fashion. In the embodiment shown, there are five line arrays 312, 314, 316, 318, and 320, each having its transducers labeled with the reference number of the respective line array.

In one embodiment, the line arrays are arranged vertically, with an optional woofer or subwoofer transducer coupled to the same cabinet preferably below the line arrays. In one preferred embodiment, the line arrays are between two and six feet tall. The line arrays may advantageously be packed horizontally as close as possible together. And within any given line array, the drivers may advantageously be packed vertically as close as possible together.

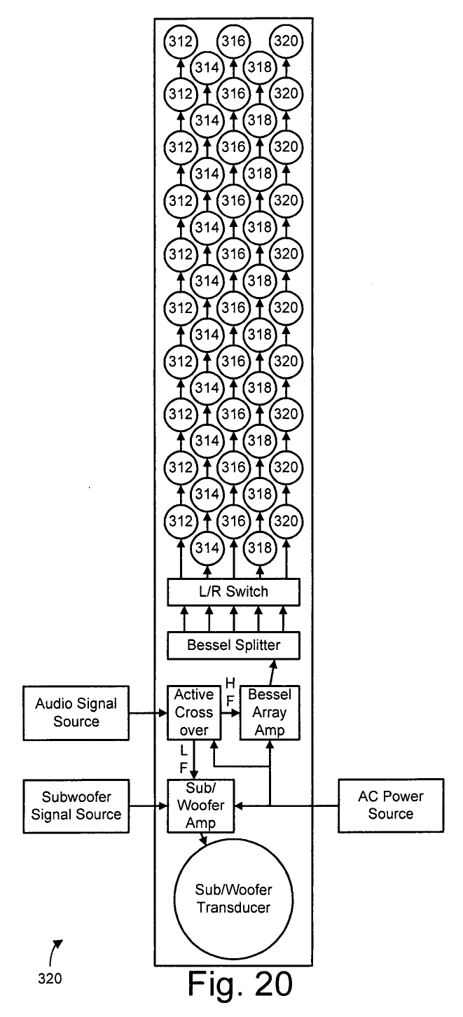

FIG. 20 illustrates yet another embodiment of a loudspeaker 320, similar to that of FIG. 19. In this embodiment, the line arrays are staggered vertically, to enable tighter horizontal packing of their transducers.

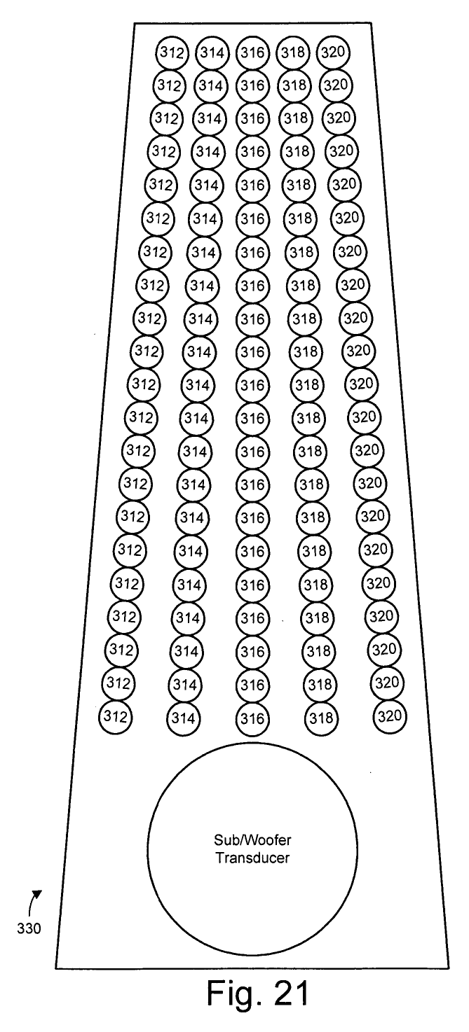

FIG. 21 illustrates yet another embodiment of a loudspeaker 330 having a plurality of line source transducers and, optionally, a subwoofer or woofer. The electronics and connections are omitted in the interest of clarity, but can be any of those taught above. In this embodiment, the line source transducers are nearly but not exactly parallel. This may cause some minor changes in the Bessel polar response of the loudspeaker, and may also offer some aesthetic and design advantages. In the embodiment shown, each line source transducer includes a plurality of moving piston transducers arranged substantially in a straight line, and the lines are close together near the top of the loudspeaker and diverge somewhat toward the bottom of the loudspeaker. In other such embodiments, ribbon transducers, planar magnetic transducers, or Heil air motion transformers could be used instead of moving piston line arrays.

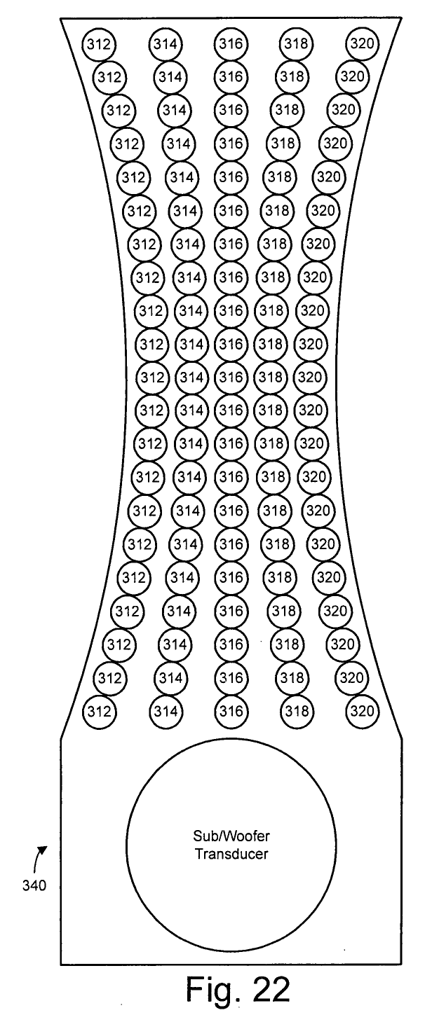

FIG. 22 illustrates yet another embodiment of a loudspeaker 340 having a plurality of line source style transducers, some of which are not necessarily configured as perfectly straight lines. In the embodiment shown, the middle line source is substantially straight, and the other line sources are increasingly curved outward, giving the overall loudspeaker a curved hourglass shape. This embodiment might most easily be constructed with line arrays of moving piston drivers, but other types of transducers could be used.

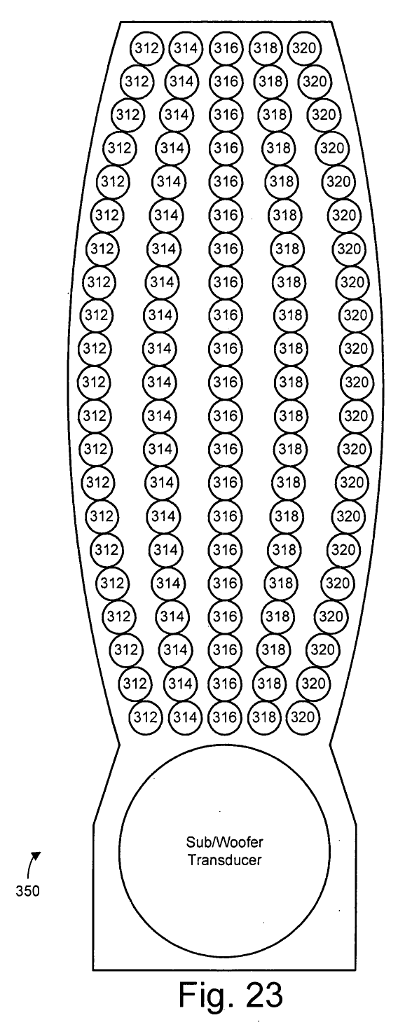

FIG. 23 illustrates yet another embodiment of a loudspeaker 350 in which the line source transducers are curved in a barrel shape.

### CONCLUSION

Armed with the teachings of this disclosure, generating the appropriate amplitudes and phases of the Bessel coefficient signals is readily within the skill of audio system engineers. For example, inverse (−) phase signals can be generated simply by reversing the wiring to a particular transducer. ½ amplitude signals can be generated either by wiring two ½ amplitude Bessel transducers in series, or with a suitable passive or active network.

Although the discussions above have generically referred to “Bessel arrays” and “Bessel coefficients”, the line source Bessel array of this invention may also be practiced in conjunction with the teachings of the parent applications of this disclosure. For example, the line source Bessel array may be operated as an “improved Bessel” or a “super Bessel”; in the low frequencies below the Bessel cutoff point, a transducer at a −1 position or a −½ position may be operated as though it were at a 0, +½, or +1 position, and a transducer at a +½ position may be operated as though it were at a +1 position. And, as indicated above, the normal 0 Bessel coefficient positions may be filled with transducers operated outside the Bessel frequency range. And, optionally, the line source Bessel array may be constructed as a “reduced Bessel” array as shown in the Ser. No. 11/358,880 application, in which an endmost one of the Bessel positions is omitted.

In a system having left and right channel pairs (e.g. left and right front, left and right surround, etc.), the left and right line source Bessel arrays may have their Bessel coefficients in mirror image positions.

In some embodiments, the line source transducers could be mounted on a slightly curved baffle, rather than on a strictly planar baffle (as shown), with, of course, potential alteration from the ideal Bessel performance, but could result in other sonic benefits, not to mention potential aesthetic benefits.

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art, having the benefit of this disclosure, will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A loudspeaker comprising:
a plurality of line source transducers disposed at regular Bessel spacing for producing sound in a line source frequency range; and
means for providing to each respective line source transducer a signal having a Bessel coefficient corresponding to that line source transducer's respective position in the Bessel spacing.

2. The loudspeaker of claim 1 wherein the plurality of line source transducers comprises one of:
a plurality of planar magnetic transducers;
a plurality of ribbon transducers;
a plurality of Heil air motion transformers; and
a plurality of line arrays, each line array including a plurality of dynamic drivers.

3. The loudspeaker of claim 1 further comprising:
at a 0 Bessel coefficient position, a driver which operates outside the line source frequency range.

4. The loudspeaker of claim 3 wherein:
the plurality of line source transducers comprises a plurality of planar magnetic transducers; and
the driver comprises a ribbon transducer operating above the line source frequency range of the planar magnetic transducers.

5. The loudspeaker of claim 1 further comprising:
a woofer operating below the line source frequency range.

6. The loudspeaker of claim 5 further comprising:
an active crossover coupled to provide a low frequency signal to the woofer and a line source frequency signal to the means for providing.

7. The loudspeaker of claim 1 wherein the means for providing includes:
means for reversing an order of the signals provided to the respective line source transducers, whereby the loudspeaker can selectably be configured as a left channel loudspeaker or a right channel loudspeaker.

8. The loudspeaker of claim 1 wherein the means for providing comprises:
a Bessel splitter for receiving a channel signal for the loudspeaker and for generating from the channel signal the respective signals provided to the respective line source transducers.

9. The loudspeaker of claim 8 further comprising:
a plurality of amplifiers each coupled to receive a respective signal from the means for providing and to amplify that signal and to provide it to the respective line source transducer.

10. The loudspeaker of claim 1 further comprising:
means for operating the plurality of line source transducers in Improved Bessel fashion.

11. The loudspeaker of claim 1 further comprising:
means for operating the plurality of line source transducers in Super Bessel fashion.

12. The loudspeaker of claim 1 wherein:
the loudspeaker and the plurality of line source transducers have one of,
a convex pot-belly shape,
a trapezoidal shape,
an hourglass shape, and
a barrel shape.

13. The loudspeaker of claim 1 wherein:
the plurality of line source transducers comprises a plurality of line arrays, each line array comprising a plurality of dynamic drivers arranged in a vertical line; and
the pluralities of line arrays in alternating Bessel array positions are vertically staggered;
whereby horizontal spacing of the Bessel array positions is reduced to less than a diameter of one of the dynamic drivers.

14. A loudspeaker comprising:
an input for receiving an audio channel signal;
a Bessel array splitter for generating from the audio channel signal a plurality of Bessel array coefficient signals; and
a plurality of line source transducers arranged in parallel on substantially equal Bessel array coefficient spacing, each line source transducer coupled to receive a respective one of the Bessel array coefficient signals.

15. The loudspeaker of claim 14 further comprising:
a left/right switch coupled between the Bessel array splitter and the line source transducers, and operable to reverse an order in which the Bessel array coefficient signals are coupled to the respective line source transducers.

16. The loudspeaker of claim 14 further comprising:
at least one additional transducer coupled to receive a voice signal carrying substantially only frequencies above an operating frequency range of the plurality of line source transducers.

17. The loudspeaker of claim 14 further comprising:
at least one additional transducer coupled to receive a voice signal carrying substantially only frequencies below an operating frequency range of the plurality of line source transducers.

18. The loudspeaker of claim 17 wherein:
the at least one additional transducer comprises a subwoofer;
the loudspeaker further comprises a subwoofer amplifier; and
wherein the subwoofer amplifier is coupled to receive the voice signal from one of a crossover filter and an external subwoofer signal source.

19. The loudspeaker of claim 14 wherein the plurality of line source transducers comprises one of:
a plurality of ribbon transducers;
a plurality of planar magnetic transducers;
a plurality of Heil air motion transformers; and
a plurality of line arrays of moving piston drivers.

20. A loudspeaker comprising:
an input for receiving an audio channel signal;
a Bessel splitter coupled to the input to receive the audio channel signal and coupled to provide a plurality of Bessel coefficient signals;
a plurality of line arrays arranged substantially in parallel on substantially equal Bessel spacing, wherein,
each line array includes a plurality of moving piston drivers, and
each line array is coupled to receive a respective one of the Bessel coefficient signals.

21. The loudspeaker of claim 20 further comprising:
a woofer operable below an operating frequency range of the moving piston drivers.

22. The loudspeaker of claim 20 wherein:
the line arrays are arranged on a Bessel spacing which includes at least one 0 Bessel coefficient position; and
the loudspeaker further includes at least one additional transducer arranged at one of the 0 Bessel coefficient positions and operable above an operating frequency range of the moving piston drivers.

23. The loudspeaker of claim 20 further comprising:
a plurality of amplifiers coupled between the Bessel splitter and the plurality of line arrays.

24. The loudspeaker of claim 20 further comprising:
a left/right switch coupled to the Bessel splitter to selectably reverse an order of the Bessel array coefficient signals.

25. The loudspeaker of claim 20 wherein:
the plurality of line arrays are arranged on Bessel spacing which is less than a diameter of one of the moving piston drivers.
